(19) United States
(12) Patent Application Publication
(10) Pub. No.: US 2004/0005419 A1
(43) Pub. Date: Jan. 8, 2004

(54) Container for product integrity and identification

(76) Inventors: Thomas M. McGrath, Rancho Cucamonga, CA (US); Sam Wah Lam, Irvine, CA (US)

Correspondence Address: WALTER A. HACKLER, 2372 S.E. BRISTOL, SUITE B, NEWPORT BEACH, CA, 92660-0755, US

(21) Appl. No.: 10/188,486

(22) Filed: Jul. 2, 2002

(51) Int. Cl. B32B 1/02

(52) U.S. Cl. 428/35.7

(57) ABSTRACT

A container for product integrity and identification includes a bottle formed from a resin comprising polypropylene and a first set of dye stuffs present in the bottle in an amount sufficient to absorb visible and ultraviolet wavelengths which may cause product degradation. An ultraviolet blocking agent is present to absorb ultraviolet wavelengths which may cause product degradation. A second set of dyestuffs is present in the bottle in an amount sufficient to provide an identifying blue color of the bottle while enabling sufficient transmission of the light for visual inspection of the product contained in the bottle.

The present invention generally relates to containers for liquid products, and is more particularly directed to a container for providing protection for contained sterile liquid ophthalmic products from degradation by light, while also permitting the visual examination of the bottle contents.

Containers for ophthalmic solutions are typically sized and shaped for enabling drop wise dispensing of ophthalmic formulations. Often however, the ophthalmic formulations are light sensitive, as for example, those including Purite® (stabilized chlorine dioxide) peroxide compounds combined with a source of chlorite ions, hydrogen peroxide or perborate. While opaque containers may be utilized for the storage and dispensing such ophthalmic formulations, they do not enable, or provide to the user, the ability to examine the container contents for remaining volume, contamination or product degradation as may be evidenced by particulates. Further, it is important that product identification play an important function for ophthalmic formulations, which may be utilized by patients who otherwise have a diminished visual acuity.

Accordingly, in accordance with the present invention, a container system provides for a bottle which can provide product integrity, enable visual inspection of contents, while at the same time providing a distinctive color which can be recognized by the user in order to prevent miss-application of ophthalmic formulations.

### SUMMARY OF THE INVENTION

A container in accordance with the present invention provides product protection/integrity and identification for an ophthalmic formulation including chlorine dioxide, or precursors to chlorine dioxide such as, for example, Purite® (stabilized chlorine dioxide) or hydrogen peroxide, perborate or other peroxide compounds with a source of chlorite ions, hereinafter generally referred to as chlorine dioxide.

The chlorine dioxide is not the active ingredient in the formulation. The container generally includes a bottle formed from a resin comprising polypropylene (PP), with a first set of dyestuffs present in the bottle in an amount sufficient to absorb visual and ultraviolet wavelengths less than about 420 nm. An ultraviolet blocking additive is also present in the resin to further absorb ultraviolet wavelengths. The blockage, or absorption, of these wavelengths prevents degradation of the chlorine dioxide.

A second set of dyestuffs is present in the bottle in an amount sufficient to significantly absorb visual wavelengths greater than about 500 nm, with the first and second dyestuffs sets allowing transmission of visual blue wavelengths for enabling the visual inspection of the product contained in the bottle and providing a product identifying color to the bottle. This latter feature enables the user of limited, or diminished capacity, eyesight to readily identify the product contained within the bottle.

A method, in accordance with the present invention, for storing a pharmaceutical formulation including chlorine dioxide, generally includes the step of forming a bottle from a resin comprising polypropylene with an ultraviolet blocker, a first set of dyestuffs present in the bottle in an amount sufficient to absorb visual and ultraviolet wavelengths less than about 420 nm and a second set of dyestuffs present in the bottle in an amount sufficient to significantly absorb visual wavelengths greater than about 500 nm. The ultraviolet blocker, and the first and second dyestuffs sets allow transmission of visual blue wavelengths for enabling visual inspection of the product contained in the bottle and providing a product identifying color to the bottle.

The method further includes the step of dispensing the pharmaceutical formulation in the bottle and sealing of the bottle.

### BRIEF DESCRIPTION OF THE DRAWINGS

The advantages and features of the present invention will be better understood by the following description when considered in conjunction with the accompanying drawing in which:

FIG. 1 is a perspective view of a container in accordance with the present invention generally including a bottle and also depicting visual observance of product disposed within the bottle;

FIG. 2 is a plot of visible light transmission as a function of wavelength for a bottle having a wall thickness of about 1 mm and formed from a mixture of PP resin particles with a natural resin to yellow/green dye resin ratio of about 10 to 1;

FIG. 3 is a plot similar to FIG. 2 with a natural resin to yellow/green dye resin ratio of about 30 to 1; and

FIG. 4 is a plot similar to FIG. 2 with a four component PP resin particle mixture comprised of about 800 parts natural resin, 1 part ultraviolet blocker, 40 parts yellow/green dye resin particles, and 80 parts of mixed resin particles incorporating either blue or purple dyes in a ratio of about 1 part blue resin to 1 part purple resin.

### DETAILED DESCRIPTION

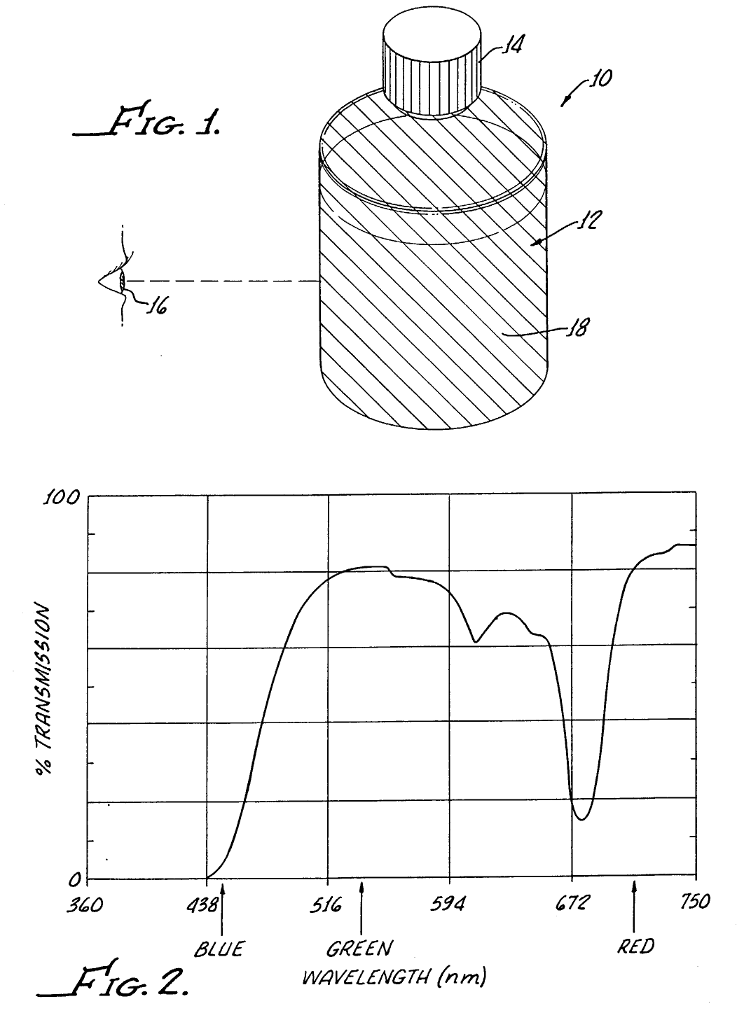

With reference to FIG. 1 there is generally shown a container 10 in accordance with the present invention for product integrity and identification. The container 10 includes a bottle 12, which is formed from a resin consisting of polypropylene (PP). The flexibility of PP at a 1 mm thickness enables the bottle 12 to be formed in a cylindrical shape and enable squeezing thereof to dispense contents therein.

A cap 14 is provided to seal a product comprising an ophthalmic formulation including chlorine dioxide within the bottle 12. Chlorine dioxide as used in the present application includes precursors to chlorine dioxide such as, for example, Purite®. Other compounds unstable to the same light wavelengths are also considered to be within the scope of the present invention.

A resin formulated with only a yellow dye, which absorbs critical wavelengths below about 400 nm also absorbs visible wavelengths of light above 500 nm, the removal of which is desired for product identification. Yellow dyes also may pass wavelengths of light (visible or ultraviolet), which degrade Purite®. It has been found that a yellow/green combination of dyes, incorporated into the PP resin, provides for complete absorption of visible wavelengths below about 400 mm with no substantial absorption of blue wavelengths. It has also been found that an ultraviolet blocker absorbs those wavelengths of ultraviolet light below about 312 nm, the removal of which is desired for product protection, which the dyestuff mixture may pass.

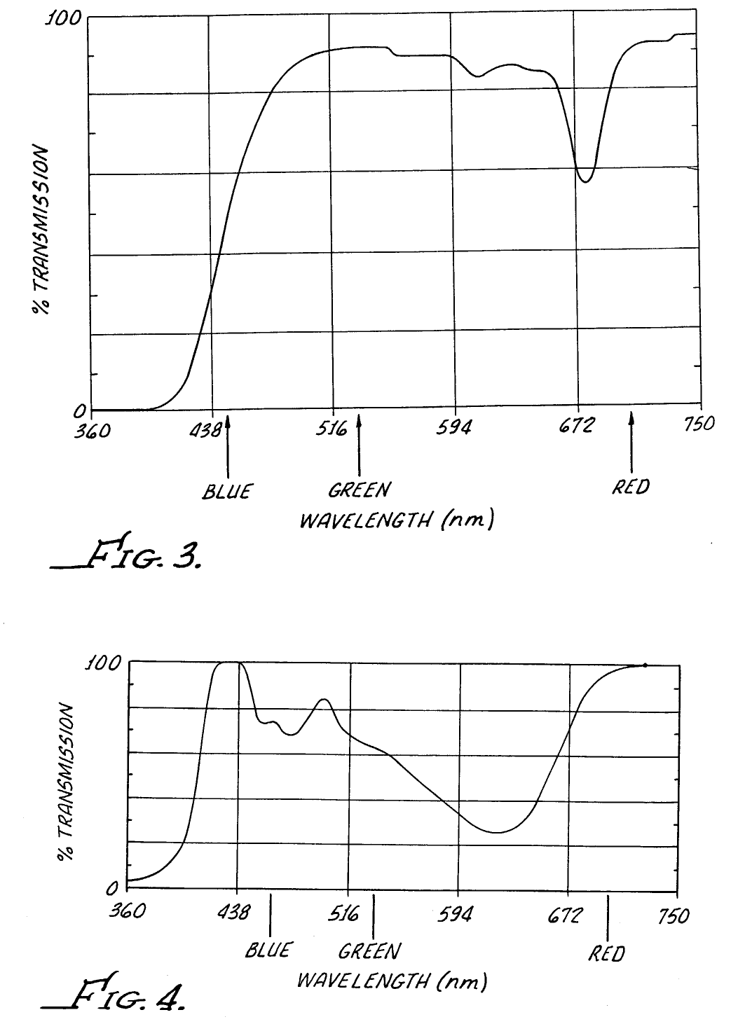

FIG. 2 shows the percent transmission of visible light as a function of wavelength for a 5 cc bottle wall section of PP with a ratio of natural PP resin pellets to yellow/green pellets to of about 10 to 1. FIG. 3 shows the percent transmission of visible light as a function of wavelength for a 5 cc bottle wall section of PP with a ratio of natural PP resin pellets to yellow/green pellets of about 30 to 1. It can be seen that the use of an increased ratio of yellow/green pellets shifts the transmission curve, thus enabling more effective shielding from undesired wavelengths, while allowing transmission of desired blue wavelengths, see arrows marked “blue”.

The resin, formulated for the bottle 12, is preferably formed from a blend of three PP resin pellets and an ultraviolet blocker. A first of the resins consists of natural PP pellets i.e. including no dyestuffs, available from Grand Polymer Ltd., Japan, (Grandpolypro J242WB)

The second resin consists of yellow/green polypropylene pellets and a first set of dyestuffs present in the bottle in an amount sufficient to absorb all visual wavelengths less than about 420 nm and additional ultraviolet wavelengths. The ultraviolet blocker absorbs those wavelengths of ultraviolet light, below about 312 nm, which are allowed to pass by the first dyestuff system. The complete absorption of these visible and ultraviolet wavelengths prevents degradation of the chlorine dioxide within the product. The ultraviolet (UV) blocking agent is available from Ciba Specialty Chemicals, Switzerland (Tinuvin 326).

Addition of yellow/green colored pellets (dyestuffs available from Toyo Ink, Japan) gives the needed continuous light absorption across the ultraviolet/visible range between about 312 nm and up to about 420 nm. It should be noted that PP itself does not absorb ultraviolet light at wavelengths below about 312 nm.

The first and second dyestuffs sets allow transmission of visual blue wavelength for enabling the visual inspection of the product contained in the bottle as indicated by the icon 16 in FIG. 1. In addition, this combination of dyestuffs provides a distinctive blue color to the bottle which identifies the product disposed therein.

As hereinabove noted, the distinctive color identification of the product is important for consumer identification both from a retail point of view and for product safety by enabling visually impaired users to readily identify the ophthalmic formulation within the bottle 12.

The final resin pellet mixture from which the bottles are molded is prepared in two stages. A pre-mixture of three types of PP resin pellets, those composed only of natural PP, blue dye containing PP, and purple dye containing PP, in a ration of about 10:1:1. These dyestuffs are available from Toyo Ink, Japan. The pre-mixture of blue, purple, and natural pellets, is further blended with the yellow/green pellets, in a premix: yellow/green ration of about 20:1 to form the final pellet mixture. These mixed pellets are heated and formed into the bottle 12 in a conventional manner. The ultraviolet blocking agent may be introduced into the final mixture from which the bottles are molded as a powder, or alternatively, by incorporation into resin pellets at the time of their formation.

The bottle preferably may have a minimum wall thickness of between about 0.5 mm and about 2 mm and a volume of between about 5 cc and about 15 cc. As shown in FIG. 1, the bottle 12 is preferably cylindrical with sides 18 for enabling dropwise squeeze dispensing of the product from the bottle 12. More specifically, the ophthalmic formulation may comprise an eye drop formulation along with the chlorine dioxide and the present invention further includes the combination of the pharmaceutical formulation and the container 10.

A method in accordance with the present invention is provided for storing a pharmaceutical formulation including chlorine dioxide. As hereinabove noted the method generally includes forming the bottle 12 from natural PP resin pellets and including in the resin a first set of dyestuffs present in the bottle in an amount sufficient to absorb visual and ultraviolet wavelengths between about 312 nm and 420 nm.

An ultraviolet blocker is also provided in the bottle to absorb ultraviolet wavelengths less than about 312 nm. The ultraviolet blocker may be added to the mixed resin pellets as a powder, or alternatively, may be incorporated into any of the PP resin pellets prior to heating and formulation of the bottle 12.

A second set of dyestuffs is also provided in the bottle in an amount sufficient to significantly absorb all visual wavelengths greater than about 500 nm. The first and second dyestuffs sets allow transmission of visual blue wavelengths for enabling visual inspection of the product contained in the bottle and providing a product identifying color to the bottle.

Thereafter the pharmaceutical formulation is disposed in the bottle and the bottle is sealed, by means, for example, but not limited to, the cap 14.

Although there has been hereinabove described a container for product protection/integrity and identification and a method in accordance with the present invention for the purpose of illustrating the manner in which the invention may be used to advantage, it will be appreciated that the invention is not limited thereto. Accordingly, any and all modifications, variations, or equivalent arrangements, which may occur to those skilled in the art, should be considered to be within the scope of the claims as defined in the appended claims.

What is claimed is:

1. A container for product protection and identification, said product comprising an ophthalmic formulation including chlorine dioxide, said container comprising:
a bottle formed from resins comprising polypropylene, said resins including
a first resin consisting of natural polypropylene;
an ultraviolet blocker in said bottle to absorb ultraviolet light at wavelengths below about 312 nm;
a second resin consisting of polypropylene and a set of dyestuffs present in said bottle in an amount sufficient to absorb most visible and ultraviolet wavelength less than about 420 nm; and
a third resin consisting of polypropylene and a set of dyestuffs present in said bottle in an amount sufficient to absorb most visible wavelengths greater than about 500 nm, the second and third resin dyestuffs sets allowing transmission of visible blue wavelengths for enabling visual inspection of the product contained in said bottle and providing a product identifying color to said bottle.

2. The container according to claim 1 wherein the ultraviolet blocking agent, and the second resin dyestuffs consist of a visible and ultraviolet blocking mixture and the third resin dyestuffs consists of a blue/purple color concentrate.

3. The container according to claim 2 wherein a ratio of first resin to second resin present in the bottle is about 20 to 1, a ratio of first to third resin present in the bottle is about 5 to 1, and a ratio of the first resin to the ultraviolet blocker is about 1000 to 1.

4. The container according to claim 3 wherein said bottle has a minimum wall thickness of between about 0.5 mm and about 2 mm and a volume of between about 5 cc about 15 cc.

5. The container according to claim 4 wherein said bottle comprises a cylindrical shape with side walls for enabling dropwise squeeze dispensing of the product from said bottle.

6. A container for product protection and identification, said product comprising an ophthalmic formulation including chlorine dioxide, said container comprising:
a bottle formed from resins comprising of polypropylene, said resins including:
a first resin consisting of natural polypropylene;
a second resin consisting of polypropylene and a set of dyestuffs present in said bottle in an amount sufficient to absorb most visible and ultraviolet wavelengths causing degradation of chlorine dioxide;
an ultraviolet light blocking agent to remove ultraviolet wavelengths causing degradation of chlorine dioxide; and
a third resin consisting of polypropylene and a set of dyestuffs present in said bottle in an amount sufficient to provide an identifying blue color to said bottle while enabling sufficient transmission of light for visual inspection of the product contained in said bottle.

7. The container according to claim 6 wherein a ratio of first resin to second resin present in the bottle is about 20 to 1, a ratio of first to third resin present in the bottle is about 5 to 1, and a ratio of the first resin to the ultraviolet blocking agent is about 1000 to 1.

8. The container according to claim 7 wherein said bottle has a minimum wall thickness of between about 0.5 mm and about 2 mm and a volume of between about 5 cc about 15 cc.

9. The container according to claim 8 wherein said bottle comprises a cylindrical shape with side walls for enabling dropwise squeeze dispensing of the product from said bottle.

10. A container for product protection and identification, said product comprising an ophthalmic formulation including chlorine dioxide, said container comprising:
a bottle formed from resins comprised of polypropylene, said bottle having a cylindrical shape, a volume of between about 5 ml and about 15 ml and walls having a thickness of between about 0.5 mm and about 2 mm for enabling dropwise squeeze dispensing of the product from the bottle, said resins including
a first resin consisting of natural polypropylene;
a second resin consisting of polypropylene and a set of dyestuffs present in said bottle in an amount sufficient to absorb most visible and ultraviolet wavelengths less than about 420 nm; an ultraviolet blocking agent to absorb ultraviolet wavelengths less than about 312 nm; and
a third resin consisting of polypropylene and a set of dyestuffs present in said bottle in an amount sufficient to absorb most visible wavelengths greater than about 500 nm, the second and third resin dyestuffs sets allowing transmission of visible blue wavelengths for enabling visual inspection of the product contained in said bottle and providing a product identifying color to said bottle.

11. The container according to claim 10 wherein a ratio of first resin to second resin present in the bottle is about 20 to 1, the ratio of first to third resin present in the bottle is about 5 to 1, and a ratio of the first resin to the ultraviolet blocking agent is about 1000 to 1.

12. A method for storing a pharmaceutical formulation comprising chlorine dioxide, said method comprising the steps of:
forming a bottle of a resin comprising polypropylene with a first set of dyestuffs present in said bottle in an amount sufficient to absorb visible and ultraviolet wavelengths less than about 420 nm, an ultraviolet blocking agent to absorb ultraviolet wavelengths less than about 312 nm, a second set of dyestuffs present in said bottle in an amount sufficient to absorb visible wavelengths greater than about 500 n, the first and second dyestuffs sets allowing transmission of visible blue wavelengths for enabling visual inspection of the product contained in said bottle and providing a product identifying color to said bottle, disposing the pharmaceutical formulation in said bottle; and sealing said bottle.
